(19) United States
(12) Patent Application Publication
(10) Pub. No.: US 2006/0054339 A1
(43) Pub. Date: Mar. 16, 2006

(54) Image processing device and image processing method

(76) Inventor: Terry Lee Domeyer, Guttenberg, IA (US)

Correspondence Address: Theresa M. Seal;C/O The Inventor's Network, Inc., 332 Academy Street, Camegie, PA, 15106, US

(21) Appl. No.: 10/937,485

(22) Filed: Sep. 10, 2004

(51) Int. Cl. H01H 23/04

(52) U.S. Cl. 174/53

(57) ABSTRACT

An electrical fixture, such as a light switch, wall outlet or ceiling fan fixture, is adapted for being quickly connected to and disconnected from an electrical housing that includes dedicated terminals mounted within the housing and to which electrical wires from the dwelling's electrical wire system are secured by retaining clips whereupon a conductor projecting from the rear of the electrical fixture can be brought into contact with the terminal and the appropriate wire thereby bringing the electrical fixture into electrical interconnection with the electrical wire system of the dwelling.

### FIELD OF THE INVENTION

The present invention pertains to the electrical interconnection of electrical wires to electrical fixtures, and more particularly pertains to an electrical housing to which the electrical wires are attached so that the wires can be interconnected to specially designed fixtures that are attachable to and detachable from the electrical housing.

### BACKGROUND OF THE INVENTION

In the construction of new dwellings such as residential homes, offices, and commercial buildings, an electrical wiring system is extended throughout the various rooms of the particular dwelling. As part of the installation of the electrical system electrical outlet boxes are mounted at various locations on the ceilings and sidewalls of the rooms of the dwelling for the interconnection of electrical fixtures like receptacles, switches, outlets and ceiling fans to the electrical system. Electrical conduit is run from the main junction box to each separate outlet box for electrically interconnecting all of the electrical fixtures to the dwelling's wiring system.

In much new construction a standard method is for the electrician to first run the electrical conduit to each outlet box so that the electrical wires can be run to the respective outlet boxes and in place. The electrician awaits the completion of the exterior wall—or ceiling—and then returns to hardwire and connect the fixtures to the wires extending in each outlet box. Thus, a two-step procedure is involved in installing electrical fixtures throughout the dwelling or structure. More significantly, should the homeowner or building operator or manager desire to upgrade, renovate or replace the particular electrical fixture, they will need to contract the services of a certified electrician as many people are uncomfortable working with electricity or simply do not want to incur the risk or danger, and therefore desire to utilize the services of a professional in the field. Thus it is desirable to have available a way to change-out and replace old fixtures without incurring the added cost and time of hiring an electrician.

The prior art discloses a range of devices that attempt to accomplish this general goal.

For example, the Barry patent (U.S. Pat. No. 3,600,008) discloses an outlet box connector that connects electrical conduit to an electrical fixture by mounting the connector within the wall opening by exerting a twisting action on the connector.

The Mattson patent (U.S. Pat. No. 3,670,094) discloses a strain relief wire holder for securing the wire of an electrical fixture and includes a wedge-shaped element that is inserted through an aperture in the back wall of the fixture for compressing and wedging the wire in place.

The Schantz patent (U.S. Pat. No. 3,824,329) discloses an electrical device housing that includes an enclosure wherein at least two relays and a push-to-start switch are secured to a common frame.

The Ochwat patent (U.S. Pat. No. 4,302,035) discloses a one-piece electrical connector that includes a frusto-conical body portion and a connector portion with the body portion including a threaded outer surface for engaging the wall aperture and seating the connector therein for supporting conduit that extends through the body portion of the electrical connector.

The Neff et al. patent (U.S. Pat. No. 4,494,779) discloses a connector fitting that includes a pair of semi-cylindrical collars that are threaded onto a corrugated conduit with the connector being supported in the wall aperture by recesses on the external surface of the semi-cylindrical collars.

The Hatagishi et al. patent (U.S. Pat. No. 5,104,333) discloses a connector apparatus that includes a pair of connectors that are mounted to the through-hole of a fixing frame with the connectors being movable and slidable to achieve a proper alignment and attachment to each other.

The Pouliot patent (U.S. Pat. No. 5,784,249) discloses an electrical distribution panel providing for the quick change-out of electrical outlets and includes a housing frame divided into distinct spaces each of which is capable of receiving an interchangeable mounting module.

The Cook patent (U.S. Pat. No. 6,071,132) discloses an electrical receptacle for connecting appliances thereto and the receptacle includes a housing having three-prong plug. The receptacle is electrically connected and mounted to the appliance so that one end of an extension cord can be coupled to the three-prong plug with the other end of the extension cord being plugged into a wall outlet for powering the appliance.

### SUMMARY OF THE INVENTION

The present invention comprehends an electrical housing for interconnecting electrical wires to an electrical fixture that is adapted for the easy and quick connection to and disconnection from the housing so that the installation, upgrade, removal and replacement of electrical fixtures, such as light switches, ceiling fans, outlets, and receptacles, can be accomplished by the electrician, or, preferably, the homeowner with a minimum expenditure of time, cost and labor.

The housing includes an aperture through which the electrical conduit enclosing the electrical wires is passed. A plurality of dedicated terminals project from the rear wall of the housing and each terminal is color-coded for receiving the unsheathed copper end of each corresponding wire. One clip is then inserted within each terminal, and the copper ends of the wires are then seated and attached to the clips. A safety cap having a pair of slots is then placed onto the prongs of each clip for holding each wire in place on their respective terminal. A lighting fixture specially designed for the quick connection to and disconnection from the housing includes at least one blade-type conductor, and the electrical fixture is pressed onto the housing for securement thereto with the blade-type conductor being aligned with and passing through the free slot of the safety cap for making the electrical interconnection with the electrical wires and, thus, to the electrical wiring system of the dwelling.

It is an objective of the present invention to provide an electrical housing for the quick connect and disconnect of electrical fixtures that reduces the work of the electrician at a new construction site by obviating the need for the electrician to return to the site after the finishing crew has completed their work.

It is another objective of the present invention to provide an electrical housing for the quick connect and disconnect of electrical fixtures that allows the homeowner to replace old electrical fixtures with new electrical fixtures without the involvement of an electrician.

It is yet another objective of the present invention to provide an electrical housing for the quick connect and disconnect of electrical fixtures that allows for the removal, replacement or upgrade of old fixtures without the need to hire an electrician or manipulate any electrical wires.

It is still yet another objective of the present invention to provide an electrical housing for the quick connect and disconnect of electrical fixtures that allows the homeowner to install, upgrade and replace electrical fixtures without the involvement of an electrician.

Another objective of the present invention is to provide an electrical housing for the quick connect and disconnect of electrical fixtures that greatly reduces the time, complexity and effort involved in installing new electrical fixtures or upgrading and replacing old electrical fixtures.

Still yet another objective of the present invention is to provide an electrical housing for the quick connect and disconnect of electrical fixtures for accomplishing the simple, efficient and inexpensive interconnection of electrical fixtures, such as outlets, receptacles, switches and ceiling fans, to the electrical main box of the dwelling

These and other objects, features and advantages will become apparent to one skilled in the art upon a perusal of the following detailed description read in conjunction with the following drawing figures and appended claims.

### BRIEF DESCRIPTION OF THE DRAWINGS

FIG. 1 is a perspective view of the preferred embodiment of the present invention illustrating the securement of the wires to the housing and the alignment and mounting of the electrical fixture to the electrical housing;

FIG. 2 is a side elevational view of the electrical housing of FIG. 1 illustrating the securement of the electrical wires to the terminals mounted within the housing and the placement of an electrical fixture on the housing;

FIG. 3 is a perspective view of the electrical housing of FIG. 1 illustrating one terminal with a retaining clip and safety cap mounted thereon;

FIG. 4 is an exploded assembly view of the electrical housing of FIG. 1 illustrating the securement of one electrical wire to the clip and the clip in alignment with the terminal so that the safety cap can be placed on the clip; and

FIG. 5 is a side elevational view of the housing and fixture first shown in FIG. 1 illustrating the attachment of one electrical wire to the clip that is seated in the terminal and a lighting fixture secured to the housing with a blade-type conductor of the fixture being in electrical interconnection with the appropriate electrical wire.

### DETAILED DESCRIPTION OF THE PREFERRED EMBODIMENT

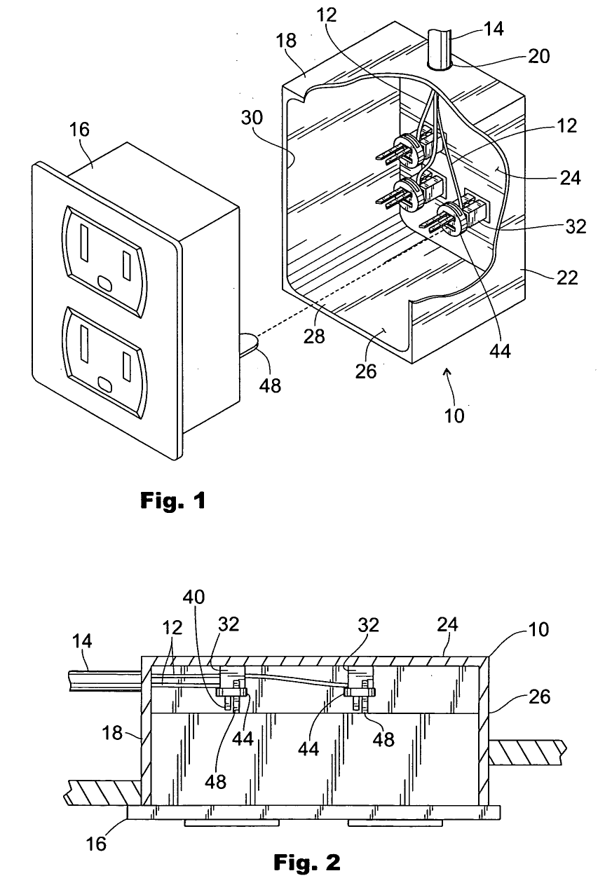

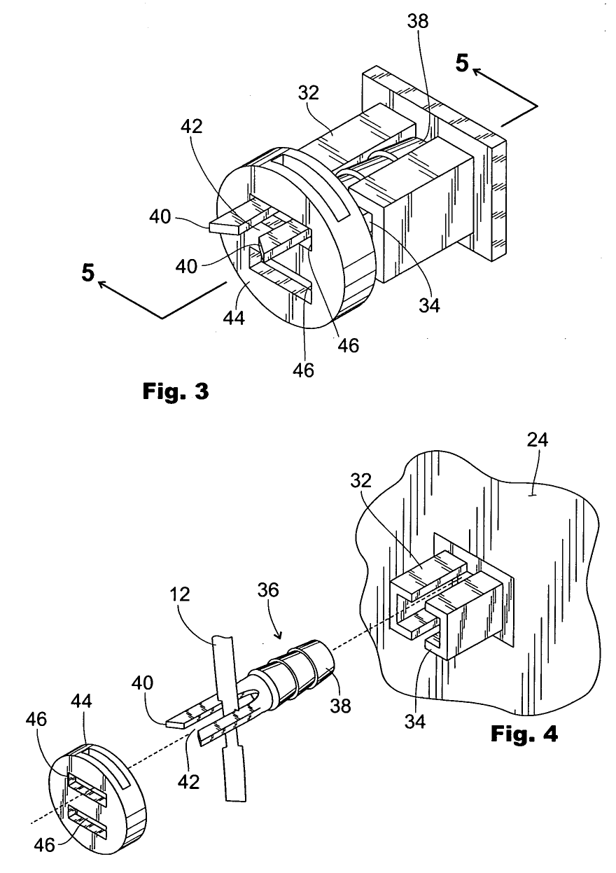

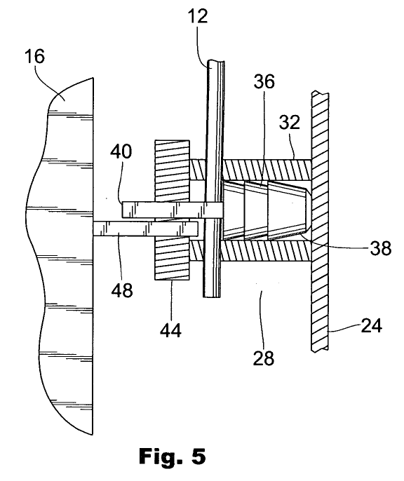

Illustrated in FIGS. 1-5 is an electrical housing or outlet box 10 for interconnecting the electrical wires 12 encased within electrical conduit 14 that is run throughout a dwelling or structure to a specially designed electrical fixture 16, a representative example being shown in FIG. 1, and which can be, for example, a light or ceiling fan, a receptacle or a light switch. The electrical housing 16 of the present invention can be mounted at various locations throughout the dwelling for tying in the electrical wiring system of the dwelling that originates from the main electrical junction box; and the electrical housing 10 of the present invention is intended to replace the standard outlet box. The specially designed electrical fixture 16 is adapted to be easily and quickly pressed on and secured to the electrical housing 10, and can be easily removed from the electrical housing 10, so that the electrical fixture 16 incorporates a quick connect and disconnect capability. Thus, the electrical fixture 16 includes plug and play ability so that the upgrade, removal or replacement of the electrical fixture 16 can be easily and quickly accomplished by an electrician, and, more importantly, by the homeowner without the need of the electrician.

As shown in FIGS. 1 and 2, the electrical housing 10 includes a top wall 18 that has an aperture 20 for allowing the passage therethrough of the electrical conduit 14 carrying the various electrical wires 12. The housing 10 also includes a pair of opposed sidewalls 22, a rear wall 24 and a bottom wall 26 thereby forming or defining a box-like enclosure for the containing the electrical wires 12. The box-like enclosure further defines an interior chamber 28 for enclosing elements that facilitate the electrical interconnection of the wires 12 to the electrical fixture 16 as hereinafter further described. The electrical housing 10 also includes a front opening 30 into which the electrical fixture 16 is pressed and plugged into place as shall be hereinafter further described.

As illustrated in FIGS. 1-5, the electrical housing 10 also includes a plurality of spaced-apart terminals 32 that are mounted to the rear wall 24 and project into the interior chamber 28 of the housing 10. The preferred embodiment of the invention includes three terminals 32 that are dedicated terminals and are color-coded for matching up with the corresponding wires 12. Thus, one terminal 32 is colored black so that the electrical wire 12 designated LI can be attached to the black-colored terminal 32; one terminal 32 is colored white so that the electrical wire 12 designated the neutral wire can be attached to the white-colored terminal 32; and one terminal 32 is colored green so that the wire 12 designated the ground wire can be attached to that terminal 32. Each terminal 32 also includes a socket or passageway 34.

Illustrated in FIGS. 1-5 are a plurality of retaining clips 36 with each clip 36 disposed within the socket 34 of one corresponding terminal 32 for securing and holding in place the respective electrical wire 12. Each clip 36 includes a generally cylindrical body portion 38 adapted to be press fit within the socket 34 of the terminal 32 so that the clip 36 can be securely mounted to the terminal 32. Each clip 36 also includes a pair of prongs 40 that extend from the body portion 38 in axial alignment therewith. The prongs 40 define a gap 42 within which the exposed copper end of the wire 12 is seated and attached. The inner surface of each prong 40 is sharp-edged to facilitate the removal of the insulation from the wire 12 as shown in FIG. 4. In addition, the clips 36—and the prongs 40—can be sized to receive and hold electrical wire 12 of various gauges, diameters and sizes.

Shown in FIGS. 1-5 is a plurality of safety caps 44 for placement on the prongs 40 of the clips 36 for preventing any accidental electrocution during the change out, upgrade or replacement of the electrical fixtures, such as the electrical fixture 16 of FIG. 1. Each safety cap 44 is cylindrical or disc-shaped and includes at least two receiving slots 46 extending through the body of the safety cap 44. When the safety caps 44 are installed at least one receiving slot 46 of each cap 44 will be slid onto the prongs 40 for securing the safety cap 44 to the terminal 32; and the installation of the safety caps 44 on the prongs 40 of the clips 36 can also be by a press fit arrangement.

As shown in FIGS. 1 and 2, the specially designed electrical fixture 16 that is adapted for the quick and easy connection to and disconnection from the electrical housing 10 is for example purposes a dual outlet wall receptacle. The electrical fixture 16 includes at least one rearward extending blade-type conductor 48 that is inserted through the free receiving slot 46 of the safety cap 44 for making the electrical interconnection with the electrical wires 12. The representative electrical fixture 16 has a box-shaped body sized to snugly fit within the front opening 30 of the housing 10 so that the homeowner can easily press and secure the electrical fixture 16 in place; and this also allows for the easy removal, upgrade and replacement of the fixture 16 when desired.

In view of the above it is relatively easy for anyone—professional electrician or homeowner—to install the electrical fixture 16 and then, as desired, upgrade or replace the fixture 16. The electrical conduit 14 is inserted through the aperture 20 of the top wall 18 and then the outside coating of the conduit 14 is stripped off to expose the variously colored copper wires 12 and the immediate insulation encasing the wires 12. The wires 12 are then matched up with the corresponding terminal 32, i.e., L1 to black, neutral to white, and ground to green. Each clip 36 will be seated within each respective terminal 32 either before of after the proceeding action. The exposed copper ends of the wires 12 are then attached to the prongs 40 for securement to the clips 36. This action also facilitates the removal of the immediate insulation of the electric wires 12. The non-conductive safety caps 44 are then secured to the clips 36 by being slid onto the prongs 40 of the clips 36 thus assisting in holding the wires 12 in position on the clips 36. Finally, the electrical fixture 16 is lined up with the front opening 30 of the housing 10 and is pressed thereon for securing the electrical fixture 16 to the housing 10. The blade-type conductor 48 of the fixture 16 aligns with the open receiving slot 46 of the safety cap 44 that is secured to the appropriate terminal 32 thereby making the electrical interconnection with the electrical wires 12. If the electrical fixture needs 16 replaced or upgraded, it is simply removed from its securement to the housing 10 and a new electrical fixture is pressed in place on the housing 10.

Thus, the foregoing is considered as illustrative only of the principles of the invention, and since numerous modifications, alterations, and variations are both possible and practicable to one skilled in the art, it is not desired to limit the invention to the exact construction and operation as shown and described, and accordingly, all suitable modifications and equivalents may be resorted while still falling within the scope of the invention and the appended claims.

I claim:

1. An electrical housing for interconnecting electrical wires to an electrical fixture, comprising:
a top wall having an aperture through which the electrical wires can be passed;
a pair of opposed sidewalls;
a rear wall;
a bottom wall with the top wall, sidewalls, rear wall and bottom wall forming a box-like enclosure for containing therein the electrical wires;
a front opening for receiving the electrical fixture so that the electrical fixture can be secured to the electrical housing;
a plurality of terminals projecting from the rear wall with each terminal dedicated to one specific electrical wire;
a plurality of retaining clips with each clip insertable into each respective terminal and partially projecting out from each terminal;
a plurality of safety caps with each safety cap mountable to each clip; and
whereupon the electrical wires are seated on the clips and the clips are inserted in the terminals with the wires being held in place by mounting the safety caps on the clips so that the securement of the electrical fixture to the housing results in the electrical fixture being brought into electrical interconnection with electrical wires.

2. The electrical housing for interconnecting electrical wires to the electrical fixture of claim 1 wherein the electrical fixture includes at least one blade-type conductor for electrically interconnecting the electrical fixture to the electrical wires.

3. The electrical housing for interconnecting electrical wires to the electrical fixture of claim 2 wherein one terminal from the plurality of terminals is colored black for connection to the electrical wire designated L1.

4. The electrical housing for interconnecting electrical wires to the electrical fixture of claim 3 wherein one terminal from the plurality of terminals is colored white for connection to the electrical wire designated the neutral wire.

5. The electrical housing for interconnecting electrical wires to the electrical fixture of claim 4 wherein one terminal from the plurality of terminals is colored green for connection to the electrical wire designated the ground wire.

6. The electrical housing for interconnecting electrical wires to the electrical fixture of claim 5 wherein each clip includes a body portion and a pair of prongs extending from the body member and defining a gap between the prongs.

7. The electrical housing for interconnecting electrical wires to the electrical fixture of claim 6 wherein the ends of the electrical wires are passed through the gaps and held by the prongs of the clips.

8. The electrical housing for interconnecting electrical wires to the electrical fixture of claim 7 wherein the safety cap includes a pair of spaced-apart receiving slots.

9. The electrical housing for interconnecting electrical wires to the electrical fixture of claim 8 wherein at least one receiving slot is slid onto the prongs for mounting the safety cap to the retaining clip.

10. For interconnecting electrical wires to an electrical fixture an electrical housing, comprising:
a box-like enclosure having an aperture through which the electrical wires are passed and a front opening for receiving the electrical fixture so that the electrical fixture can be secured to the electrical housing;
a plurality of terminals with each terminal dedicated to a specific function of each corresponding electrical wire;
a plurality of retaining clips with clips mounted to the terminals so that the electrical wires can be attached to the clips;
a plurality of safety caps with one safety cap placed on each respective clip after the electrical wire has been attached to that clip for holding the wire on the clip and preventing electrocution during change out and replacement of the electrical fixture; and
the securement of the electrical fixture to the electrical housing brings the electrical fixture in electrical interconnection with the electrical wires so that the electrical fixture can be powered and operated.

11. The electrical housing for electrically interconnecting electrical wires to an electrical fixture of claim 10 wherein the electrical fixture includes at least one blade-type conductor for making the electrical interconnection with the electrical wires.

12. The electrical housing for electrically interconnecting electrical wires to an electrical fixture of claim 11 wherein one terminal of the plurality of terminals is designated the L1 terminal for connection to the electrical wire that is colored black.

13. The electrical housing for electrically interconnecting electrical wires to an electrical fixture of claim 12 wherein one terminal of the plurality of terminals is designated the neutral terminal for connection to the electrical wire colored white.

14. The electrical housing for electrically interconnecting electrical wires to an electrical fixture of claim 13 wherein one terminal of the plurality of terminals is designated the ground terminal for connection to the electrical wire colored green.

15. The electrical housing for electrically interconnecting electrical wires to an electrical fixture of claim 14 wherein each clip includes a body portion and a pair of prongs that extend from the body portion and define a gap between the prongs.

16. The electrical housing for electrically interconnecting electrical wires to an electrical fixture of claim 15 wherein the exposed copper ends of the electrical wires are passed between the prongs for attachment to the clips.

17. The electrical housing for electrically interconnecting electrical wires to an electrical fixture of claim 16 wherein the safety caps each include a pair of receiving slots.

18. The electrical housing for electrically interconnecting electrical wires to an electrical fixture of claim 17 wherein at least one receiving slot for each safety cap is slid onto the prongs of the respective clip for mounting the safety cap to the clip and preventing accidental electrocution during change out or replacement of the electrical fixture.

19. The electrical housing for electrically interconnecting electrical wires to an electrical fixture of claim 18 wherein the safety caps are composed of an electrically non-conductive material.

20. An electrical housing, comprising:
a top wall having an aperture so that electrical wires can be passed through the aperture;
a pair of opposed sidewalls;
a rear wall;
a bottom wall with the top wall, sidewalls, rear wall and bottom wall forming a box-like enclosure for containing the electrical wires therein;
a front opening for receiving an electrical fixture that is removably securable to the electrical housing;
a plurality of terminals projecting from the rear wall with each terminal color-coded so that the specific electrical wire can be mounted thereon;
a plurality of retaining clips with each clip mountable to each terminal so that the appropriate electrical wire can be attached to the clip; and
a plurality of electrically non-conductive safety caps with each safety cap disposed on each clip after the attachment of the respective electrical wire to that clip for preventing accidental electrocution during the change out or replacement of the electrical fixture.
